(19) United States
(12) Patent Application Publication
(10) Pub. No.: US 2005/0169289 A1
(43) Pub. Date: Aug. 4, 2005

(54) Method for broadcasting of a possibility to use 3g mobile communication network

(76) Inventors: Guillaume Sebire, Espoo (FI); Rami Vaittinen, Littoinen (FI)

Correspondence Address: HARRINGTON & SMITH, LLP, 4 RESEARCH DRIVE, SHELTON, CT, 06484-6212, US

(21) Appl. No.: 10/501,019

(22) PCT Filed: Jan. 9, 2003
(86) PCT No.: PCT/FI03/00013

(30) Foreign Application Priority Data
Jan. 10, 2002 (SE) 20020048

(51) Int. Cl. H04B 7/212

(52) U.S. Cl. 370/412; 370/348

(57) ABSTRACT

A method with which cellular network terminals are informed of a possibility to use services of 3G mobile communication networks in a radio access network. A spare bit of the broadcast message SI3 of GSM system is defined as a bit indicating, whether the current GERAN cell supports UMTS service through the Iu interface or not. In a favourable case, another SI message is broadcast including a description of the PBCCH where Iu information for mobile stations is placed. Should the GERAN support also the GPRS service, said another message is SI13, and if the GERAN does not support the GPRS service, said another message is SI13alt. This message can only be employed by UMTS capable mobile stations. By means of the invention the information presumed by the use of the UMTS network can quickly be acquired by a mobile station, which for example arrives in a GERAN cell.

The invention relates to a method with which cellular network terminals are informed of a possibility to use services of a 3G mobile communication networks in a radio access network.

### BACKGROUND OF THE INVENTION

So-called third generation mobile communication network means an extension of the present mobile communication networks, which increases and improves services of the network. The abbreviation UMTS (Universal Mobile Telecommunications System) is often used of third generation or 3G mobile communication network. FIG. 1 shows a simplified example of the structure of a GSM (Global System for Mobile communications) type mobile communication network. The network comprises a core network CN and radio access networks RAN. Core network includes traditional GSM centres and normally also other service nodes. FIG. 1 shows one traditional GSM centre MSC (Mobile Switching Centre) and one SGSN (Serving GPRS Support Node) handling packet switched information transfer, in which GPRS means corresponding service (General Packet Radio Service). Furthermore, in the core network of the example can be seen two 3G service nodes, 3GNs and 3GNp. Radio access networks are located between the core network and network terminals. A radio access network includes one or more base transceiver stations BTS and a base station controller BSC. Each base transceiver station has a fixed connection to the base station controller of the area in question, which BSC in turn has a fixed connection to at least one core network node. Connection to a conventional GSM centre corresponds to so-called A interface service mode, connection to a SGSN node corresponds to so-called Gb interface service mode (same as GPRS) and connection to a 3G node corresponds to so-called Iu interface service mode. This can be cs type (circuit switched), or ps type (packet switched). Radio access network GERAN (GSM/EDGE RAN), EDGE=Enhanced Data rates for Global Evolution, in FIG. 1 has said four connections to the core network. Naturally a GERAN does not necessarily have all types of interfaces.

In the traffic area, or cell of a base transceiver station BTS1 of the network GERAN is also shown one terminal, i.e. mobile station MS. A “GERAN cell” means in this description that kind of cell, which is under control of a GERAN. Moreover, FIG. 1 shows another radio access network RAN2. This can be e.g. GERAN or UTRAN (UMTS Terrestrial RAN).

Each frequency division channel of a digital mobile communication system includes, in addition to traffic channels, a group of control channels realized by means of time division. To control channels belong e.g. broadcast control channels (BCCH in the GSM system) intended to be traced by all mobile stations in the area, common control channels used jointly by certain mobile stations, and dedicated control channels and associated control channels used by each mobile station individually during speech or data connection. In a cell supporting GPRS, GPRS-specific control channels may be used in addition to the control channels required in a basic GSM system, namely PBCCH (Packet Broadcast Control Channel) and PCCCH (Packet Common Control Channel), or P channels. A GERAN supporting Iu requires these P channels in the cells where UMTS service through the Iu interface is provided irrespective whether this GERAN supports GPRS.

Control information of different layers is transferred in channels in messages having defined format. The present invention relates to the operation of layer 3, i.e. network layer as regards radio access networks, in other words to controlling of so-called radio resources RR. There are several groups of RR messages, among which are system level broadcast messages, or SI (System Information) messages. These are aimed at broadcasting information that is needed for the mobile station to operate properly in the system in question.

Message SI3 is sent at relatively short intervals on the BCCH. It has room e.g. for GPRS indicator, which informs mobile stations whether GPRS service is supported in the cell in question or not. Further information concerning GPRS service in this cell is sent in a message SI13 to the BCCH of this cell. In cells that support GPRS service could in principle also Iu support-related information be sent on the BCCH for example in messages SI13. In a GERAN cell that supports UMTS service but not GPRS service this possibility does not exist, because SI13 messages are then not sent. From conference publication “Service Modes and System Information” (Nov. 26-30, 2001), Ericsson Ltd, is known a proposal for adding a two-bit field in the part of the message SI3. The field would inform mobile stations about the Iu service mode. However, there is only one spare bit left in the SI3 Rest Octets at present. There is no room for the required information in other messages sent regularly to the BCCH.

### SUMMARY OF THE INVENTION

An object of the invention is to remove said disadvantage associated with the prior art. The method according to the invention is characterized by what is specified in the independent claim 1. Some preferred embodiments of the invention are specified in the other claims.

The basic idea of the invention is as follows: A spare bit of the broadcast message SI3 of GSM system is defined as a bit indicating, whether the current GERAN cell supports UMTS service through the Iu interface or not. In a favourable case, another SI message is broadcast including a description of the PBCCH where Iu information for mobile stations is placed. Should the GERAN support also the GPRS service, said another message is SI13, and if the GERAN does not support the GPRS service, said another message is SI13alt. This message can only be employed by UMTS capable mobile stations.

An advantage of the invention is that the information presumed by the use of the UMTS network can quickly be acquired by a mobile station, which for example arrives in a GERAN cell. The speed is based on the use of a SI3 message sent in the BCCH.

Of course the advantage only relates to mobile stations being capable of using UMTS service through GERAN Iu interface. “Iu mobile station” in this description and patent claims means such a mobile station. Correspondingly, “Gb mobile station” means a mobile station being capable of using GPRS service through GERAN Gb interface.

### BRIEF DESCRIPTION OF THE DRAWINGS

In the following the invention is explained in more detail. The description refers to the attached drawings, in which

FIG. 1 shows a basic structure of a GSM type mobile communication network,

FIG. 2 shows a prior art rest part of SI3 message,

FIG. 3 shows a rest part of SI3 message according to the invention, and

FIG. 4 shows in a flow chart an example of the method according to the invention.

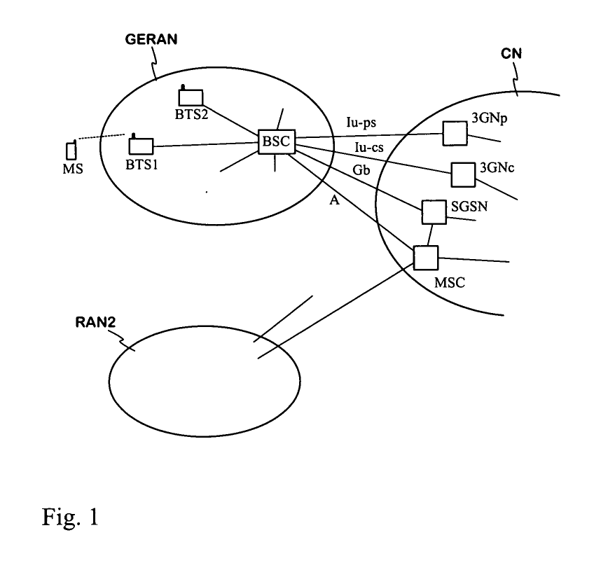

### DETAILED DESCRIPTION OF THE INVENTION

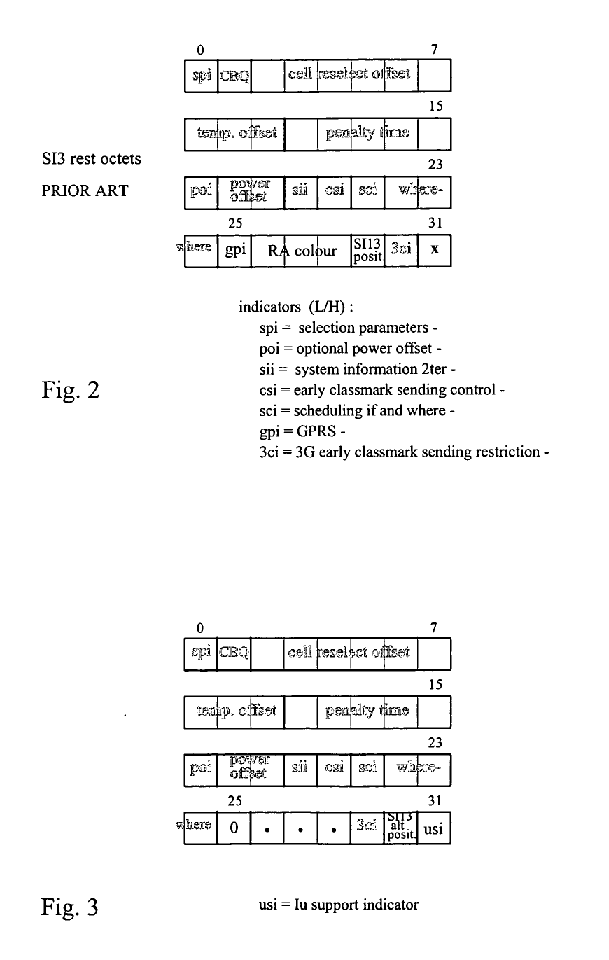

In FIG. 2 there is a diagram of the rest part of the SI3 message having four octets. The form of the rest octets is valid at present (Release 4 of 3GPP). In the diagram there are marked with grey those fields, which are mostly linked with the handover of servicing base transceiver station during a speech connection, and are nonsubstantial from the point of view of the present invention. Bit number 25 (gpi) in rest octets indicates the presence of the GPRS indicator and informs, whether the current GERAN cell supports the GPRS service or not. If the bit gpi is “low”, GPRS is not supported and the GPRS indicator is not present. If the bit gpi is “high”, GPRS is supported, and the GPRS indicator is present. The GPRS indicator consists of the fields “RA COLOUR” and “SI13 POSITION” (bits number 26-29 in the octets) to arrange the packet switched service. From the point of view of the invention is important the last bit x, which is a spare bit.

With a syntax used in standards the contents of the SI3 rest octets is as follows:

<SI3 Rest Octet> ::= <Optional selection parameters>

<Optional Power offset>
<System Information 2ter Indicator>
<Early Classmark Sending Control>
<Scheduling if and where>
{ L | H <GPRS Indicator> }
<3G Early Classmark Sending Restriction>
{ L | H <SI2quater Indicator : < SI2quater Indicator struct >> }
<spare padding>;

<Optional Selection Parameters> ::= L | H <Selection Parameters>;
<Selection Parameters> ::=

<CBQ: bit (1)>
<CELL_RESELECT_OFFSET: bit (6)>
<TEMPORARY_OFFSET: bit (3)>
<PENALTY_TIME: bit (5)>;

<Power Offset indicator> ::= L | H;

<Power Offset: bit (2)>;

<System Information 2ter Indicator> ::= L | H;
<Early Classmark Sending Control> ::= L | H;
<Scheduling if and where>::= L | H <WHERE: bit (3)>;
<GPRS Indicator> ::= L | H;

< RA COLOUR : bit (3) >
< SI13 POSITION: bit >;

<3G Early Classmark Sending Restriction>::=

L -- Neither UTRAN nor cdma2000 classmark change message

shall be sent with the Early classmark sending

H ; -- The sending of UTRAN and cdma2000 classmark Sending

messages is controlled by the Early Classmark Sending Control parameter
< SI2quater Indicator struct >::=
< SI2quater_POSITION : bit >;

FIG. 3 shows an example of the rest part of SI3 message according to the invention. When compared with FIG. 2, it is seen that previously unused bit x is now an Iu support indicator usi. The state “low” of this bit indicates that the current cell, or the cell in which the message is sent, of a GERAN does not support UMTS service through an Iu interface between this GERAN and 3G type centre of a core network. The state “low” of the Iu support indicator can as well be used in order to prevent any UMTS operation through Iu interface in the current cell, whereupon this cell is barred against UMTS operation. An Iu only mobile station shall not (re)select such a cell, and therefore the cell is barred against Iu only mobile stations. The state “high” of the Iu support indicator bit means that the current cell of a GERAN supports UMTS service through the Iu interface. (Also) in this case said cell can be such that it either supports or does not support the GPRS service. In the example of FIG. 3 the cell does not support the GPRS service, for which reason the GPRS indicator is not present. This means that the room of the GPRS indicator, i.e. the room of fields “RA COLOUR” and “SI13 POSITION” in FIG. 2, is released. The released room is used to place the Iu indicator field. This field is formed, in the example of FIG. 3, of a bit “SI13alt POSITION” in the spot 30 of the rest octets. The existence of the Iu indicator field means that a SI13alt message is sent including a description of the PBCCH. The state of bit “SI13alt POSITION” indicates, whether the SI13alt message is transferred in a normal BCCH or in BCCH extended by its capacity. When a cell of a GERAN supports the GPRS service, too, there is no room for the Iu indicator field. 3G mobile station can then look for the description of the PBCCH in the SI13 message transferred on the BCCH, on grounds that the GPRS indicator bit is present.

Corresponding the changes in accordance with the invention the line
“<spare padding>;” in the listing above is replaced by a line
<Iu support indicator>;—Iu support indication
   and to the end of the listing are added lines
<Iu support indicator>:: =L|H|H<Iu indicator>;
<Iu indicator>:: =<SI13alt POSITION: bit>;
   where “SI13alt POSITION” defines the minimum schedule for where the SI13alt message is sent as:
0 SI13alt message is sent on the channel BCCH normal
1 SI13alt message is sent on the channel BCCH extended.

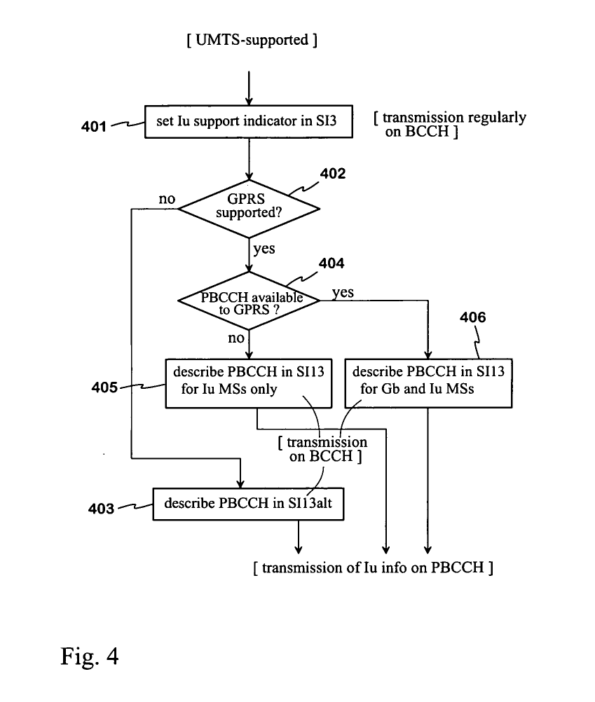

FIG. 4 shows as a flow chart an example of the method for indicating a possibility to use 3G mobile communication network according to the invention. The starting point then is that a cell of the radio access network in question supports the UMTS service, concerning at least a part of the cells being under control of the radio access network. In step 401 is formed a message SI3 so that the Iu support indicator bit is included in the message. The SI3 message is sent at relatively short intervals on the BCCH. In step 402 it is checked whether said cell supports the GPRS service. If not, the PBCCH is described, according to step 403, in a SI13alt message so that Iu mobile stations will be able to get Iu information from PBCCH. SI13alt message is sent on the BCCH, and it is illegible to other than Iu mobile stations; they ignore the message. If said cell supports the GPRS service, it is checked in the SI13 message whether PBCCH and PCCCH are available to GPRS (step 404). If not, the PBCCH is described for Iu mobile stations only, according to step 405, in a SI13 message. That message is sent on the BCCH, and its PBCCH description part is illegible to other than Iu mobile stations. If the PBCCH is available to GPRS, the PBCCH is described (step 406) in a SI13 message, sent on the BCCH, for Iu mobile stations and for GPRS mobile stations. The same PBCCH channel is then used to transfer both GPRS and Iu information.

In all cases the Iu information is sent on the PBCCH.

An Iu mobile station, camped on a GERAN cell, which offers UMTS service, operates in a way corresponding to the above-explained:
If in a SI3 message received from the BCCH, the mobile station detects the GPRS indicator being not present and if it finds the Iu support indicator bit being in state “high”, it shall assume that GPRS is not supported and Iu is supported in the cell. Then it shall read the Iu indicator where it finds the field “SI13alt POSITION”. The mobile station will then read the SI13alt message from the BCCH, normal or extended depending on the SI13alt position, and decode the description of the PBCCH therein. It will then be able to read the Iu information from the PBCCH.
If in a SI3 message received from the BCCH, the mobile station detects the GPRS indicator being present and if it finds the Iu support indicator bit being in state “high”, it shall assume that both GPRS and Iu are supported in the cell, and that no Iu indicator is included in the SI3 message. The mobile station will then read the SI13 message from the BCCH, normal or extended depending on the SI13 position in the GPRS indicator, and decode the description of the PBCCH therein. It will then be able to read the Iu information from the PBCCH.
If the mobile station finds the Iu support indicator bit being in state “low” in a SI3 message received from the BCCH, it shall assume Iu is not supported in the cell and shall operate as a 1 G or 2G mobile station, which can use services provided through A and Gb interfaces.

Above it was described the principle of the invention. The invention is not limited just to the described matter. It can be applied in different ways within the scope defined by the independent claim.

1. A method for broadcasting of a possibility to use UMTS service in a cell under control of a GERAN type radio access network having an Iu interface to a 3G core network, a radio resource management system of the radio access network comprising a first and a second message, which messages are transferred on a first broadcast control channel in said cell, and which first message has at least one spare bit, wherein said first message is System Information 3 of GSM system, and the method comprises using of said spare bit for indicating whether said cell supports an UMTS service, and in a favourable case
describing a second broadcast control channel in the second message to at least Iu mobile stations, and
broadcasting UMTS service information for Iu mobile stations on the second broadcast control channel.

2. The method of claim 1, said first channel being BCCH of the GSM system and said second channel being PBCCH of the GSM system.

3. The method of claim 1, the radio access network supporting the UMTS-service and not supporting a GPRS service, wherein said first message further comprises an Iu indicator field, and said second message is System Information 13alt of the GSM system and is legible only to Iu mobile stations.

4. The method of claim 1, the radio access network supporting both the UMTS service and a GPRS service, wherein said second message is System Information 13 of the GSM system.

5. A method of claim 4, the second channel being available also to the GPRS service, wherein said message System Information 13 is legible only to Iu mobile stations and Gb mobile stations.

6. A method of claim 4, the second channel being not available to the GPRS service, wherein a description of the second channel in the message System Information 13 is legible only to Iu mobile stations.

7. A method of claim 3, said Iu indicator field indicating, whether normal BCCH or extended BCCH is used to transfer the second message.

8. The method of claim 1, said cell being barred against UMTS operation through Iu interface by indicating with said spare bit that UMTS service is not supported in said cell.
